(19) United States
(12) Patent Application Publication
(10) Pub. No.: US 2021/0396915 A1
(43) Pub. Date: Dec. 23, 2021

(54) OPTICAL LENS, IMAGING DEVICE, AND ELECTRONIC DEVICE USING SAME

(71) Applicant: HON HAI PRECISION INDUSTRY CO., LTD., New Taipei (TW)

(72) Inventors: PO-CHOU CHEN, Tu-Cheng (TW); CHUN-CHENG KO, New Taipei (TW)

(21) Appl. No.: 17/034,286

(22) Filed: Sep. 28, 2020

(30) Foreign Application Priority Data
Jun. 17, 2020 (CN) 202010555862.6

(51) Int. Cl. G02B 5/00; G02B 5/26; G02B 7/02; G02B 5/20; G02B 13/18; H04N 5/225

(52) U.S. Cl. CPC G02B 5/003; G02B 5/26; G02B 7/021; H04N 5/22525; G02B 13/18; H04N 5/2254; G02B 5/208

(57) ABSTRACT

An optical lens includes a first lens, a filter, and a shading sheet between the first lens and the filter. The first lens is configured to emit a first light with a wavelength in a first wavelength range and a second light in a second wavelength range. The filter is after the first lens, allowing the through transmission of the first light for imaging but reflecting the second light. The shading sheet absorbs at least a part of the second light. An imaging device and an electronic device using same are also provided.

### FIELD

The subject matter herein generally relates to imaging.

### BACKGROUND

A lens module is configured to receive ambient light for imaging. The lens module usually includes a filter and a sensor. The filter transmits ambient light of a certain wavelength and reflects remaining portion of the ambient light. The ambient light transmitted by the filter enters the sensor to be recorded as images. Ambient light reflected by the filter can be reflected again by other structures other than the filter and the sensor in the lens module and can finally reach the sensor, as stray light. The stray light causes light spots and reduce an imaging quality of the lens module, for example, reducing imaging clarity, reducing imaging layering, reducing imaging color saturation, etc.

Therefore, there is room for improvement in the art.

### BRIEF DESCRIPTION OF THE DRAWINGS

Implementations of the present disclosure will now be described, by way of embodiment, with reference to the attached figures.

FIG. 1 is a perspective view of an electronic device having an imaging device according to an embodiment of the disclosure.

FIG. 2 is a cross-sectional view of the imaging device of FIG. 1.

FIG. 3 is a perspective view in three dimensions of the structure of a first lens and a filter of the imaging device of FIG. 2.

FIG. 4 is a cross-sectional view of the first lens and the filter shown in FIG. 3.

FIG. 5 shows an imaging effect of a comparative imaging device.

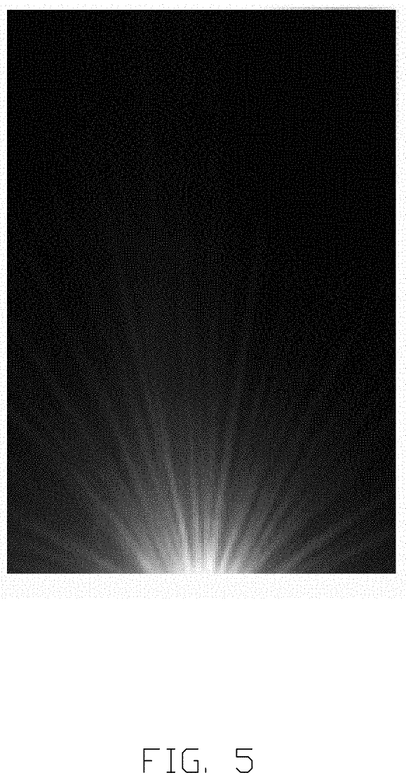

FIG. 6 shows an imaging effect of the disclosed embodiment of the imaging device.

### DETAILED DESCRIPTION

It will be appreciated that for simplicity and clarity of illustration, where appropriate, reference numerals have been repeated among different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as connected, whether directly or indirectly through intervening components, and is not necessarily limited to physical connections. The connection can be such that the objects are permanently connected or releasably connected. The term “comprising” when utilized, means “including, but not necessarily limited to”; it specifically indicates open-ended inclusion or membership in the so-described combination, group, series, and the like.

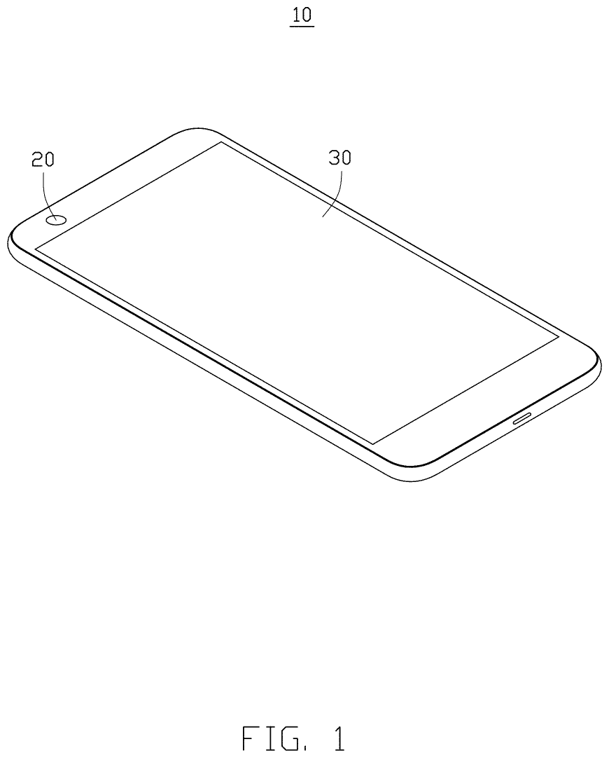

FIG. 1 shows an electronic device 10 of an embodiment. In this embodiment the electronic device 10 is a smart phone with an image-capturing function. In other embodiments, the electronic device 10 may be other types of electronic device with that function, such as a tablet computer.

The electronic device 10 includes an imaging device 20 and a display panel 30 electrically connected to the imaging device 20. The imaging device 20 is configured for receiving ambient light of surrounding environment generating signals according to the ambient light, which can be taken as images. The display panel 30 is configured to display images according to the signals.

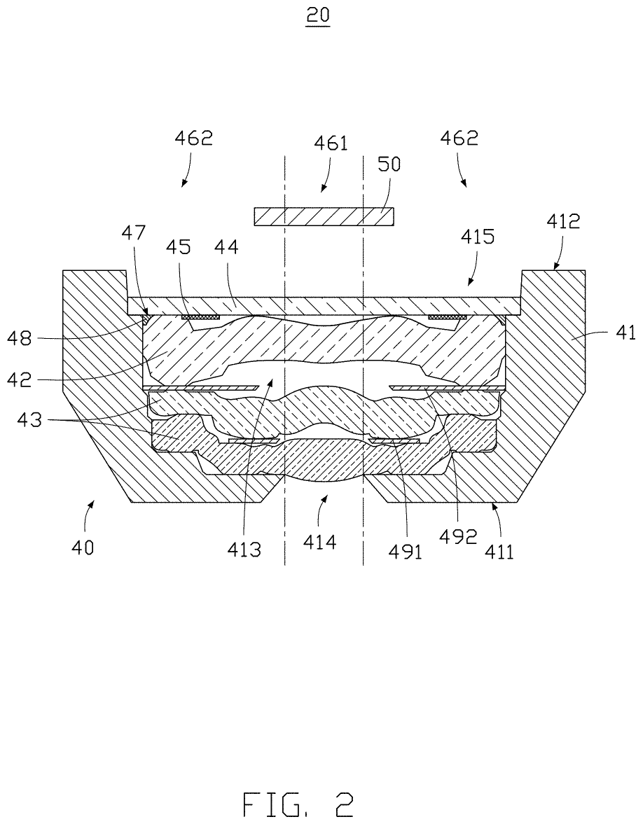

FIG. 2 shows the imaging device 20 including an optical lens 40 and an image sensor 50. The optical lens 40 is configured for receiving the ambient light and emitting a first light. The image sensor 50 is located on a side where the optical lens 40 emits the first light and receives the first light and generates signals accordingly.

The optical lens 40 includes a substantially cylindrical lens barrel 41. The lens barrel 41 has a first end 411 and a second end 412 opposite to each other. The first end 411 has a light-entry opening 414, and the second end 412 has a light-exiting opening 415. A receiving space 413 is formed between the first end 411 and the second end 412. The ambient light enters the optical lens 40 from the light-entry opening 414. The first light exits from the light-exiting opening 415.

The optical lens 40 further includes a lens group including a plurality of lenses. In this embodiment, the lens group includes a first lens 42 and two second lenses 43 on a side of the first lens 42 away from the image sensor 50. The first lens 42 and the two second lenses 43 are accommodated in the receiving space 413. That is, the first lens 42 and the two second lenses 43 are arranged axially in order, along a direction from the second end 412 to the first end 411. The present disclosure does not limit a specific number of the second lens 43 in the lens group. The lens group (in this embodiment, the first lens 42 and the two second lenses 43) constitute an optical system for modulating the ambient light and guiding a modulated ambient light (that is, the first light) to the image sensor 50.

The optical lens 40 further includes a filter 44 on a side of the first lens 42 away from the two second lenses 43. The ambient light includes a first light with a wavelength in a first wavelength band and a second light with a wavelength in a second wavelength band. The filter 44 allows transmission of the first light but reflects the second light.

In this embodiment, the filter 44 is an infrared filter, the first wavelength range is the spectrum of the visible light, and the second wavelength range is the range of wavelengths containing infrared light. That is, the first light is visible light, the second light is infrared light, and the filter 44 is configured to transmit visible light and to reflect infrared light. The infrared light is prevented from entering the image sensor 50 by being reflected by the filter 44, which further helps to avoid infrared light signals interfering with images.

The optical lens 40 further includes a shading sheet 45 between the filter 44 and the first lens 42. The shading sheet 45 is configured to absorb at least a part of the second light reflected by the filter 44. In this embodiment, the shading sheet 45 is a SOMA film.

The first lens 42, the two second lenses 43, and the filter 44 all have a light-transmitting area 461 and a flange area 462. The flange area 462 always surrounds the light-transmitting area 461. The light-transmitting area 461 of the first lens 42, the two second lenses 43, and the filter 44 are configured to focus light for imaging. The flange areas 462 of the first lens 42, the two second lenses 43, and the filter 44 act to secure the alignment of the lenses (that is, the first lens 42, the two second lenses 43, and the filter 44) together. In this embodiment, an orthographic projection of the image sensor 50 on the filter 44 is at least partially located in the light-transmitting area 461. In this embodiment, the shading sheet 45 is annular in shape and located in the flange area 462. That is, an orthographic projection of the shading sheet 45 on the filter 44 is in the flange area 462.

The electronic device 10, the imaging device 20, and the optical lens 40 provided in this embodiment include a first lens 42, two second lenses 43, a filter 44, and a shading sheet 45. The ambient light enters through the light-entry opening 414, passes through the two second lenses 43 and the first lens 42, then enters the filter 44. The filter 44 reflects the second light but allows transmission of the first light. The first light transmitted by the filter 44 enters the image sensor 50. The image sensor 50 generates an image signal according to the first light to transmit the image signal to the display panel 30 to control the display panel 30 to display images. The reflected second light is at least partially absorbed by the shading sheet 45, this reduces the amount of second light which might be reflected by other structures (structures other than the filter 44 and the shading sheet 45 in the optical lens 40). The influence of second light on imaging quality is thus reduced.

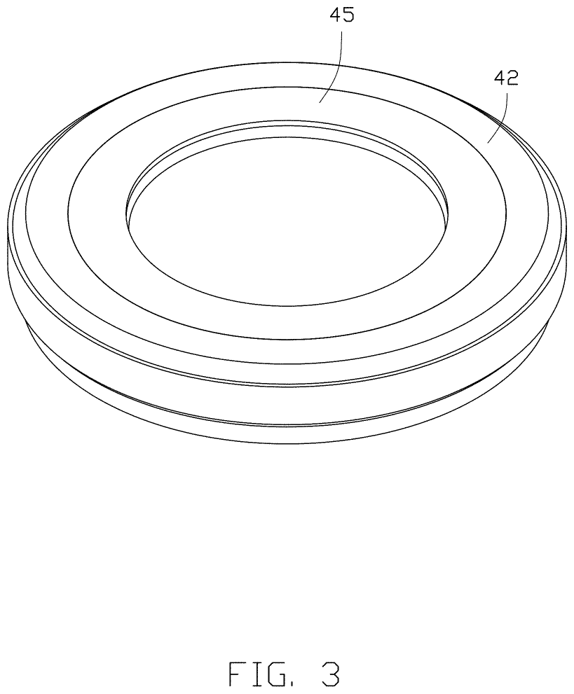

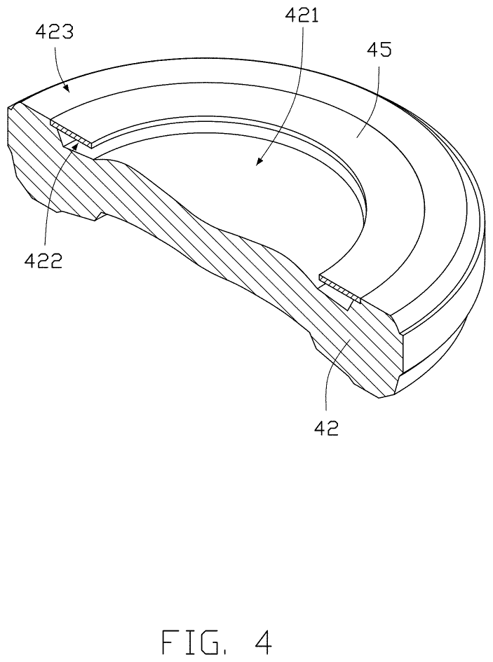

FIGS. 3 and 4 show the first lens 42 and the filter 44. The first lens 42 has a surface 421 close to the filter 44. An annular-shaped groove 422 is formed on the surface 421 in the flange area 462 for receiving the shading sheet 45. In other embodiments, the shading sheet 45 is not circular, and the groove 422 is not annular. The present disclosure does not limit the shading sheet 45 and the groove 422 to specific shapes. In this embodiment, a position of the shading sheet 45 in the optical lens 40 is fixed by the groove 422, which avoids shifting of the shading sheet 45.

The surface 421 of the first lens 42 also has a platform area 423 arranged around the groove 422. The platform area 423 is a flat surface, and directly attached to the filter 44 when the first lens 42 is assembled into the optical lens 40, to improve a structure stability of the first lens 42 and the filter 44.

The first lens 42, the lens barrel 41 and the filter 44 jointly define a filling space 47 for accommodating glue 48 when the first lens 42 is assembled into the optical lens 40. The glue 48 is configured to attach the first lens 42 and the filter 44 to an inner wall of the lens barrel 41, to improve a positional stability of the first lens 42 and the filter 44 in the lens barrel 41, and further for fixing the shading sheet 45 in place.

In this embodiment, the optical lens 40 further includes an annular first shading portion 491 and an annular second shading portion 492 in the flange area 462. That is, orthographic projections of the first shading portion 491 and the second shading portion 492 on the first lens 42, the second lens 43 and the filter 44 are in the flange area 462. The first shading portion 491 is between the two second lenses 43, and the second shading portion 492 is between the first lens 42 and one second lens 43 close to the first lens 42. In this embodiment, both the first shading portion 491 and the second shading portion 492 are SOMA films for shielding or absorbing light received. The first light shading portion 491 and the second light shading portion 492 reduce the amount of second light and thus have less effect on an imaging quality of the first light.

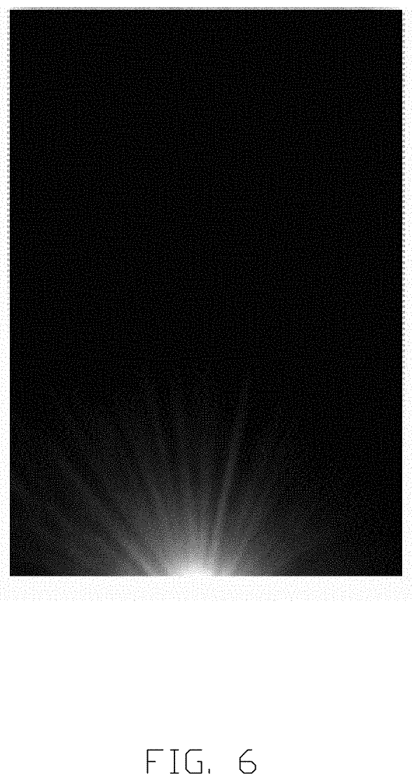

An image displayed by an optical lens, an imaging device, and an electronic device in the prior art has flares and non-optimal image quality. Referring to FIG. 6, an image displayed by the optical lens 40, the imaging device 20, and the electronic device 10 provided in this embodiment reduces problem of flares and improves the image quality.

It is to be understood, even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present embodiments to the full extent indicated by the plain meaning of the terms in which the appended claims are expressed.

What is claimed is:

1. An optical lens, comprising:
a first lens, the first lens configured to emit a first light with a wavelength in a first wavelength range and a second light with a wavelength in a second wavelength range;
a filter on a side of the first lens emitting the first light and the second light, the filter being configured to transmit the first light for imaging and reflect the second light; and
a shading sheet between the first lens and the filter, the shading sheet being configured to absorb at least a part of the second light.

2. The optical lens of claim 1, wherein the first lens defines a light-transmitting area and a flange area surrounding and independent from the light-transmitting area;
the shading sheet is annular shaped, and an orthographic projection of the shading sheet on the first lens is in the flange area.

3. The optical lens of claim 2, wherein a groove is defined in a surface of the first lens close to the filter, the groove is configured for accommodating the shading sheet.

4. The optical lens of claim 2, wherein a surface of the first lens close to the filter has an annular platform area in the flange area, the platform area is in directly contact with the filter.

5. The optical lens of claim 2, further comprising:
a lens barrel comprising a first end and a second end opposite to the first end; and
a receiving space between the first end and the second end, wherein
the first lens, the shading sheet, and the filter are arranges along a direction from the first end to the second end in the receiving space.

6. The optical lens of claim 5, wherein the filter, the lens barrel, and the first lens cooperatively define a filling space, and
the filling space is filled with glue for fixing each of the filter and the first lens to the lens barrel.

7. The optical lens of claim 5, further comprising at least one second lens on a side of the first lens away from the filter.

8. The optical lens of claim 1, wherein the first wavelength range is in a wavelength range of visible light, and the second wavelength range is in a wavelength range of infrared light.

9. An imaging device, comprising:
an optical lens, comprising:
a first lens, the first lens configured to emit a first light with a wavelength in a first wavelength range and a second light with a wavelength in a second wavelength range;
a filter on a side of the first lens emitting the first light and the second light, the filter being configured to transmit the first light for imaging and reflect the second light; and
a shading sheet between the first lens and the filter, the shading sheet being configured to absorb at least a part of the second light; and
an image sensor on a side where the optical lens emits the first light and being configured to receive the first light and generate an image signal according to the first light for imaging.

10. The imaging device of claim 9, wherein the first lens defines a light-transmitting area and a flange area surrounding and independent from the light-transmitting area;
the shading sheet is annular shaped, and an orthographic projection of the shading sheet on the first lens is in the flange area.

11. The imaging device of claim 10, wherein a groove is defined in a surface of the first lens close to the filter, the groove is configured for accommodating the shading sheet.

12. The imaging device of claim 10, wherein a surface of the first lens close to the filter has an annular platform area in the flange area, the platform area is in directly contact with the filter.

13. The imaging device of claim 10, further comprising:
a lens barrel comprising a first end and a second end opposite to the first end; and
a receiving space between the first end and the second end, wherein
the first lens, the shading sheet, and the filter are arranges along a direction from the first end to the second end in the receiving space.

14. The imaging device of claim 13, wherein the filter, the lens barrel, and the first lens cooperatively define a filling space, and
the filling space is filled with glue for fixing each of the filter and the first lens to the lens barrel.

15. The imaging device of claim 13, further comprising at least one second lens on a side of the first lens away from the filter.

16. The imaging device of claim 9, wherein the first wavelength range is in a wavelength range of visible light, and the second wavelength range is in a wavelength of infrared light.

17. An electronic device, comprising:
an imaging device, comprising:
an optical lens, comprising:
a first lens, the first lens configured to emit a first light with a wavelength in a first wavelength range and a second light with a wavelength in a second wavelength range;
a filter on a side of the first lens emitting the first light and the second light, the filter being configured to transmit the first light for imaging and reflect the second light; and
a shading sheet between the first lens and the filter, the shading sheet being configured to absorb at least a part of the second light; and
an image sensor on a side where the optical lens emits the first light and is configured to receive the first light and generate an image signal according to the first light for imaging; and
a display panel electrically connected to the imaging device and configured to display images according to the image signal.
